(19) United States
(12) Patent Application Publication
(10) Pub. No.: US 2017/0190983 A1
(43) Pub. Date: Jul. 6, 2017

(54) PROCESS OF CONVERTING NATURAL PLANT OILS TO BIOFUELS

(71) Applicant: Montana State University, Bozeman, MT (US)

(72) Inventors: Nestor SORIANO, Havre, MT (US); Randy MAGLINAO, Havre, MT (US); Akash NARANI, Havre, MT (US); Md Joynal ABEDIN, Havre, MT (US)

(21) Appl. No.: 15/301,636

(22) PCT Filed: Apr. 1, 2015
(86) PCT No.: PCT/US15/23848

§ 371 Date: Oct. 3, 2016

Related U.S. Application Data
(60) Provisional application No. 61/973,518, filed on Apr. 1, 2014.

(51) Int. Cl. C10G 3/00; B01J 31/16; B01J 31/22; C10G 45/00

(52) U.S. Cl. CPC C10G 3/48; C10G 45/00; B01J 31/1625; B01J 31/2273; B01J 31/2278; C10G 2400/08; B01J 2231/543; B01J 2531/821

(57) ABSTRACT

The conversion of renewable feedstock, particularly camelina oil, into jet fuel and other high-value chemicals. The conversion comprises the processes of alkene metathesis, dehydrogenation, hydrogenation, and vacuum distillation.

### CROSS-REFERENCE TO RELATED APPLICATIONS

This application claims priority to U.S. provisional application No. 61/973,518 titled “PROCESS OF CONVERTING NATURAL PLANT OILS TO BIOFUELS”, filed Apr. 1, 2014, the entire disclosure of which is incorporated herein by reference.

### BACKGROUND

The development of advanced transportation fuels for use in the aviation industry has been increasingly compelled by the need to reduce the environmental impact of air transportation and to provide energy security. Aviation is one of the fastest growing transportation sectors globally, and is expected to grow by 5% annually. This will contribute to a six-fold increase in CO₂ emissions by air transportation alone, considering the current rate of fuel consumption and CO₂ emissions, or only 3% if the projected technological advancements and operational improvements in the aviation sector are achieved. Recent studies have also indicated that aircraft contribute to about 3.5% of global warming attributed to human activity, and will potentially increase up to 15% in 50 years. The major contributions of aircraft to climate change are primarily caused by CO₂ and NOx emissions. Other emissions include water vapor, CO, hydrocarbons, SOx, sulfate particles and soot.

The U.S. consumes about 22 billion gallons of the 73 billion gallons of jet fuel produced worldwide. The utilization of domestic renewable jet fuel at 20% of the U.S. current consumption level would reduce the country's oil imports by about 3.2 billion gallons annually. The U.S. Air Force targets deriving 50% of its total fuel consumption from renewable resources by 2016, while the U.S. Navy has set the same goal for 2020. This amounts to the use of about 325 million gallons of renewable advanced fuel by 2016. Unified research and development roadmaps were identified by the government and the private sector that will assist in accelerating the development and deployment of renewable aviation fuels. In the last quarter of 2010, the U.S. Department of Agriculture, Air Transportation Association and Boeing have collaborated to establish the “Farm to Fly” initiative with the primary objective of developing and advancing a comprehensive sustainable aviation biofuel rural development plan. With almost exactly the same goals, the European Commission, Airbus, and representatives from Aviation and Biofuels producers industries launched the “European Advanced Biofuels Flightpath” during the early quarter of 2011. This initiative targets the deployment of 1.2 million tons of renewable aviation fuels annually from 2014 to 2018 as its short term goal, which will be increased to 2.0 million tons by 2020.

Since 2007, there had been several successful demonstration flights conducted by the U.S. Air Force and other commercial airlines in the U.S., Europe and Asia using alternative jet fuels. These alternative jet fuels varied from synthetic paraffinic kerosene (SPK) produced via a Fischer-Tropsch (FT) process or hydroprocessed esters and fatty acids (HEFA) produced from the hydrotreating of natural oils. While SPK and HEFA are both non-oxygenated, containing carbon chain lengths comparable to conventional jet fuel, they have deficiencies in fuel properties, mainly due to the lack of aromatic content. Nevertheless, to-date, SPK and HEFA are the only alternative jet fuels that have been certified by ASTM under the D7566 specification, “Aviation Turbine Fuel Containing Synthesized Hydrocarbons”. This standard allows for the blending of kerosene-like renewable fuels with conventional commercial and military fuels up to 50% blend levels. The establishment of the ASTM D7566 specification alleviates another barrier in the deployment of renewable jet fuels in commercial scale.

Aside from the lack of aromatic content, both SPK and HEFA present economic and production challenges. To-date, none of the commercial scale FT facilities are located in the U.S. The four commercially viable technologies based on the FT process are located in South Africa, the Middle East and Asia, using coal and natural gas as feedstock. Moreover, both SPK and HEFA are produced using a very energy intensive process requiring relatively higher temperatures and pressures to achieve a reasonable conversion.

### SUMMARY OF THE INVENTION

The present invention is directed to a method and system for preparing a transportation fuel from a renewable feedstock.

In one embodiment, the invention is directed to a process comprising providing a renewable feedstock comprising an unsaturated fatty acid glyceryl ester, contacting a mixture of the feedstock and C₂-C₅ olefins with a metathesis catalyst, whereby the unsaturated fatty acid glyceryl ester and C₂-C₅ olefin undergo a cross-metathesis reaction, thereby forming a metathesis product comprising medium-chain fatty glyceryl esters, acyclic olefins, cyclic olefins, and optionally unreacted C₂-C₅ olefins.

In another embodiment, the metathesis product is dehydrogenated in the presence of a hydrogenation catalyst and substantially less than a stoichiometric amount of hydrogen gas relative to the amount of unsaturated bonds in the metathesis product. These conditions provide a dehydrogenated metathesis product comprising medium-chain fatty glyceryl esters, acyclic olefins, cyclic olefins, optionally unreacted C₂-C₅ olefins, and aromatics. The dehydrogenated metathesis product can then be hydrogenated in the presence of a hydrogenation catalyst and hydrogen. This forms a hydrogenated mixture comprising medium-chain saturated fatty glyceryl esters, acyclic and cyclic saturated hydrocarbons, and aromatics. The hydrogenated mixture itself can meet the specifications of jet fuel, or a blend comprising at least 50% of the hydrogenated mixture and a fuel blendstock, meets or exceeds the specifications of jet fuel.

In still another embodiment, the metathesis product is separated to obtain a fraction containing C₉-C₁₃ olefins and a fraction containing olefins with less than nine carbon atoms. The fraction containing C₉-C₁₃ olefins is hydrogenated to obtain hydrocarbon fuel and the fraction containing olefins with less than nine C atoms is subjected to a cycloaddition reaction to obtain a mixture of bicyclic and polycyclic hydrocarbons containing fused four, five, six, seven, eight or nine-membered rings. The mixture of bicyclic and polycyclic hydrocarbons can be used as high density aviation fuel.

In one embodiment, the invention provides heterogeneous metathesis catalysts and methods for preparing heterogeneous metathesis catalysts. In some embodiments, the heterogeneous metathesis catalysts of the invention comprise metathesis catalysts, such as Grubbs catalysts, immobilized on silica or other suitable solid supports.

In yet another embodiment, the invention provides heterogeneous metathesis catalysts, for example Grubbs catalysts, having a polymerizable ligand, which upon polymerization forms a polymer-supported Grubbs catalyst.

In still other embodiments, the invention provides heterogeneous metathesis catalysts, for example polymer-supported Grubbs catalysts, immobilized on silica or other suitable solid supports.

In various embodiments, the silica and/or polymer supported Grubbs catalysts can be utilized for heterogeneous conversion of unsaturated fatty acid glyceryl esters (e.g., a plant oil such as camelina oil) into olefins, for example in a continuous reactor.

### BRIEF DESCRIPTION OF THE DRAWINGS

FIG. 1 is an exemplary, non-limiting illustration of an embodiment of a system for carrying out the process of the present invention;

FIG. 2 is a flow diagram illustrating an embodiment of the process of the present invention;

FIG. 3 is a flow diagram illustrating another embodiment of the process of the present invention;

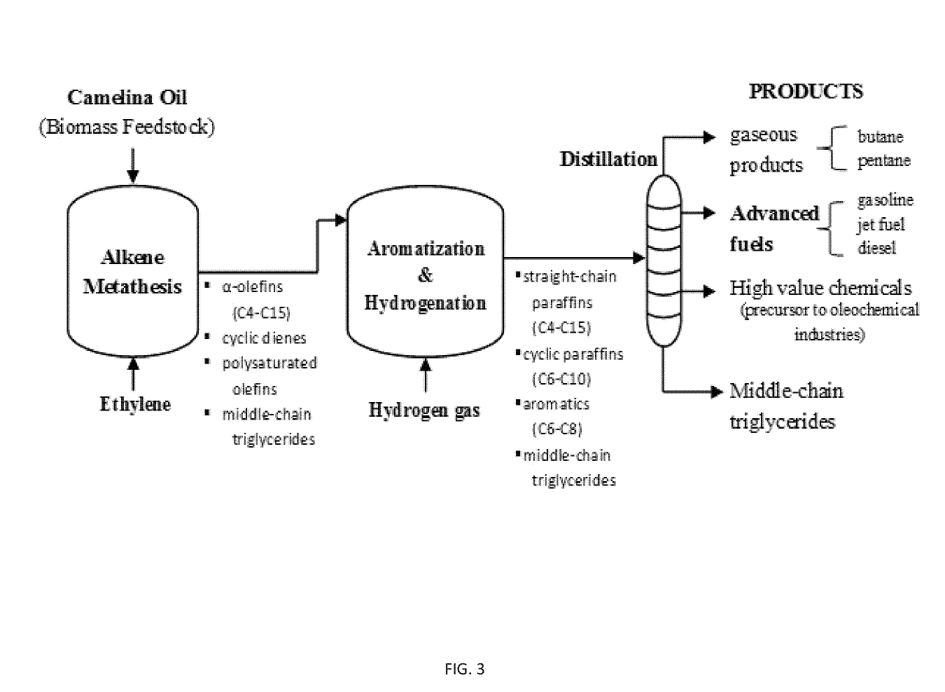

FIG. 4 is an illustration of various chemical conversions during dehydrogenation according to embodiments of the invention; and

FIG. 5 is a flow diagram illustrating another embodiment of the process of the present invention.

### DETAILED DESCRIPTION

All documents disclosed herein (including patents, journal references, ASTM methods, etc.) are each incorporated by reference in their entirety for all purposes.

The following definitions are used herein or are otherwise known to a skilled artisan. Except where stated otherwise, the following definitions apply throughout the specification and claims. Chemical names, common names, and chemical structures may be used interchangeably to describe the same structure. These definitions apply regardless of whether a term is used by itself or in combination with other terms, unless otherwise indicated. Hence, for example, the definition of “alkyl” applies to “alkyl” as well as the “alkyl” portions of “hydroxyalkyl,” “haloalkyl,” “alkoxy,” etc.

“Alkyl” means a monovalent aliphatic hydrocarbon group or radical which may be considered to be formed by the loss of a hydrogen from an alkane. An alkyl group may be linear or branched. In some embodiments, alkyl groups may comprise from about 1 to about 20 carbon atoms in the chain. In other embodiments, alkyl groups comprise from about 1 to about 12 carbon atoms in the chain. In still other embodiments, alkyl groups comprise from about 1 to about 6 carbon atoms in the chain.

The term “branched” in reference to an alkyl group means that one or more carbon atoms in the chain are attached to three or four other carbon atoms in the chain.

The term “substituted alkyl” means that the alkyl group may be substituted by one or more substituents, each of which may be the same or different. Non-limiting examples of such substituents include, for example, halogen, alkenyl, alkynyl, haloalkyl, —OH, —O—, —C(O)—, haloalkoxy, alkoxy, cycloalkyl, cycloalkyloxy, heterocycloalkyl, heterocycloalkyloxy, aryl, aryloxy, heteroaryl, heteroaryloxy, —NO₂, and —CN.

“Alkenyl” means an aliphatic unsaturated hydrocarbon group or radical having at least one carbon-carbon double bond. An alkenyl group may be linear or branched and may comprise, for example, from 2 to about 15 carbon atoms in the chain. In some embodiments, alkenyl groups have 2 to about 12 carbon atoms in the chain, and in other embodiments, 2 to about 6 carbon atoms in the chain.

The term “branched” in reference to an alkenyl group means that one or more carbon atoms in the alkenyl chain are attached to three or four other carbon atoms in the alkenyl chain.

“Alkynyl” means a hydrocarbon group or radical having at least one carbon-carbon triple bond. An alkynyl group may be linear or branched and may, for example, comprise from 2 to about 15 carbon atoms in the chain. In some embodiments, alkynyl groups have from 2 to about 12 carbon atoms in the chain, and in other embodiments, from 2 to about 4 carbon atoms in the chain.

The term “branched” in reference to an alkynyl group means that one or more carbon atoms in the chain are attached to three or four other carbon atoms in the chain.

“Aryl” means an aromatic monocyclic or polycyclic group. An aryl group may comprise at least 6 carbon atoms in the aromatic ring (i.e., phenyl), in other embodiments 10 or more carbon atoms in two or more aromatic rings. The aryl group may optionally be substituted with one or more “ring system substituents” which may be the same or different, and are as defined below. Non-limiting examples of suitable aryl groups include phenyl and naphthyl.

“Ring system” means an aromatic monocyclic or multi-cyclic ring (i.e., “aryl”), a partially unsaturated ring (e.g., cyclohexenyl), or a fully saturated ring (e.g., cyclohexanyl). “Ring system” also includes rings in which one or more of the ring carbon atoms are replaced with elements other than carbon, such as nitrogen, oxygen and sulfur. A ring system may comprise, for example, from 3 to about 14 ring atoms, in some embodiments about 5 to about 10 ring atoms, and in other embodiments, about 5 to about 6 ring atoms. A ring system may optionally be substituted with one or more “ring system substituents” which may be the same or different. A ring system may include, for example, cycloalkyl, heterocycloalkyl, aryl, or heteroaryl rings, as defined herein, as well as partially unsaturated cycloalkyl or heterocycloalkyl rings (e.g., cyclohexenyl, thiazolinyl, etc.).

“Non-aromatic ring system” means any ring system as defined above, but excluding aryl or heteroaryl rings.

“Cycloalkyl” means a non-aromatic (i.e., aliphatic) mono-, bi- or polycyclic ring system comprising, for example, about 3, about 4, about 5, about 6, about 7, about 8, about 9, about 10, about 11, about 12, about 13, 14, or about 15 carbon atoms in the ring or rings, inclusive of all ranges and subranges between any of these values. For example, in some embodiments the number of carbon atoms in the cycloalkyl ring system ranges from about 5 to about 14 carbon atoms. In other embodiments, the number of carbon atoms in the cycloalkyl ring system ranges from about 5 to about 10 ring atoms. The cycloalkyl ring system can be optionally substituted with one or more “ring system substituents” which may be the same or different, and are as defined below. Non-limiting examples of suitable monocyclic cycloalkyls include cyclopropyl, cyclopentyl, cyclohexyl, cycloheptyl and the like. Non-limiting examples of suitable polycyclic cycloalkyls include 1-decalinyl, norbornyl, adamantyl and the like.

“Heterocycloalkyl” means a non-aromatic monocyclic or polycyclic ring system comprising, for example, about 3, about 4, about 5, about 6, about 7, about 8, about 9, or about 10 ring atoms, inclusive of all ranges and subranges of ring atoms therebetween. In some embodiments, the number of ring atoms ranges from about 5 to about 10 ring atoms, in which one or more of the atoms in the ring system is an element other than carbon, for example nitrogen, oxygen or sulfur. If more than one ring atom is an element other than carbon, the non-carbon ring atoms may be the same or different. Preferred heterocycloalkyl ring systems comprise from about 5 to about 6 ring atoms. The prefix “aza”, “oxa” or “thia” before the heterocycloalkyl root name means that at least one of the ring atoms is respectively a nitrogen, oxygen or sulfur atom. Any —NH— in a heterocycloalkyl ring may be present in protected form such as, for example, as an —N(Boc)-, —N(CBz)-, —N(Tos)- group and the like; such protected —NH— groups are also considered part of this invention. The heterocycloalkyl may optionally be substituted by one or more “ring system substituents” which may be the same or different, and are as defined above. The nitrogen or sulfur atom of the heterocycloalkyl may optionally be oxidized to the corresponding N-oxide, S-oxide or S,S-dioxide. Non-limiting examples of suitable monocyclic heterocycloalkyl rings include piperidyl, pyrrolidinyl, piperazinyl, morpholinyl, thiomorpholinyl, thiazolidinyl, 1,4-dioxanyl, tetrahydrofuranyl, tetrahydrothiophenyl, and the like.

The term “substituted” means that one or more hydrogens bonded to the designated atom or group is replaced with a selection from the indicated group, provided that the normal valency of the designated atom or group under the existing circumstances is not exceeded, and that the substitution results in a stable compound. Combinations of substituents and/or variables are permissible only if such combinations result in stable compounds. By “stable compound” or “stable structure” is meant a compound that is sufficiently robust to survive isolation to a useful degree of purity from a mixture.

It should also be noted that any heteroatom with unsatisfied valences in the text, schemes, examples and Tables herein is assumed to have sufficient hydrogen atoms to satisfy the valences.

As used herein, the term “composition” is intended to encompass a product comprising a combination of any specified ingredients in any specified amounts, as well as any product formed, directly or indirectly, from the combination of any specified ingredients in any specified amounts.

The term “feedstock” is defined as a raw material or mixture of raw materials supplied to a process from which other products can be made. The term feedstock is used interchangeably with the term “renewable feedstock”, as the feedstocks used are generated from biomass or traditional carbohydrates, which are renewable substances.

The term “biomass” as used herein refers primarily to the stems, leaves, and starch-containing portions of green plants.

The term “conversion” is defined as the percentage of the substrate reacted to form products, and the term “yield” is defined as the amount of product obtained per unit weight of raw material. The yield may be expressed as a percentage of the theoretical yield, or as g product/g substrate. “Theoretical yield” is defined as the maximum amount of product that can be generated per a given amount of substrate as dictated by the stoichiometry of the chemical or metabolic pathway used to make the product.

The term “primarily” in reference to a component of a composition of the present invention refers to a composition which comprises at least 50% of the referenced component.

The term “byproduct” means an undesired product related to the production of biofuel or biofuel precursor. Byproducts are generally disposed of as waste, thereby increasing the cost of the process.

The term “co-product” means a secondary or incidental product related to the production of biofuel. Co-products have potential commercial value that increases the overall value of biofuel production, and may be the deciding factor as to the viability of a particular biofuel production process.

The terms “alkene” and “olefin” are used interchangeably herein to refer to non-aromatic hydrocarbons having at least one carbon-carbon double bond.

The term “dehydrogenation” refers to any process which results in the removal of hydrogen. Dehydrogenation may include, but is not limited to, aromatization and oxidation. For example, cyclohexene or cyclohexadiene can be dehydrogenated in the presence of a suitable catalyst to form benzene.

The term “hydrogenation” refers to a chemical reaction between molecular hydrogen (H₂) and another compound or element. It is hence the reverse of dehydrogenation. For example, olefins can be hydrogenated to form the corresponding saturated hydrocarbon.

The term “metathesis” refers to the metal-catalyzed rearrangement of carbon-carbon double bonds between two reacting chemical species by scission and regeneration of the carbon-carbon double bonds. One generally accepted, non-limiting mechanism is disclosed in Vougioukalakis, G. C.; Grubbs, R. H., Ruthenium-based heterocyclic carbene-coordinated olefin metathesis catalysts. Chemical Reviews 2010, 110(3), 1746-87, which discusses the formation of metallacyclobutane intermediates through coordination between olefin(s) and a transition metal alkylidene. The term “metathesis” includes self-metathesis (i.e., metathesis of two identical olefins) and cross-metathesis (i.e., metathesis of two different olefins). When cross-metathesis is performed with ethylene, it may also be referred to as “ethenolysis”. When self-metathesis of a linear or branched olefin result in cyclization, it may also be referred to as “ring closing metathesis”, or RCM. Olefins may also isomerize during metathesis.

The term “rearrangement” refers to a chemical reaction in which alkyl groups on a hydrocarbon migrate to different positions on a carbon backbone molecule during a chemical reaction, such as during an oligomerization, metathesis, dehydration, dehydrogenation, or other reaction. For example, the expected product of the dehydration of 1- or 2-butanol without rearrangement is 1- or 2-butene. With rearrangement, the migration of hydrogen and alkyl groups to other positions forms, for example, isobutene. Rearrangement can also refer to reactions in which the migration of a hydrogen atom changes the position of a carbon-carbon double bond in an alkene (for example, hydrogen migrations which interconvert 1-butene and 2-butenes).

The term “reactor” refers to the part of the reaction vessel or system where the substrates and chemical intermediates contact a catalyst to ultimately form product. The reactor for a simple reaction may be a single vessel containing a single catalyst. For a reaction requiring two different catalysts, the reactor can be a single vessel containing a mixture of the two catalysts, a single vessel such as a tube reactor which contains the two catalysts in two separate layers, or two vessels with a separate catalyst in each which may be the same or different.

The term “ASTM” refers to the American Society for Testing and Materials.

The term “saturated” refers to the oxidation state of a hydrocarbon molecule in which all bonds are single C—C or C—H bonds. Saturated acyclic hydrocarbons have a general molecular formula of CₙH₂ₙ₊₂.

The term “cetane number” refers to a measure of combustion quality of fuel during compression ignition, as described in O'Connor et al. Fuels 1992 71, 1323-1327. O'Connor estimates the cetane numbers of specific subsets of hydrogenated butene oligomers by a proton nuclear magnetic resonance (NMR) spectroscopy method. In the method, a correlation is made between cetane number and the ratio of the number of methylene and methine group protons in the mixture to the number of methyl group protons. The numbers of each type of protons are counted for the mixtures by integrating the appropriate region of the proton NMR spectrum (0.65-0.98 ppm for methyl protons, 0.99-1.75 ppm for methylene and methine protons). O'Connor describes a correlation for branched hydrocarbons produced by small olefin oligomerization which is applicable to butene oligomers. The formula for calculating the cetane numbers of saturated hydrocarbons in the C₁₀-C₂₀ range is:

Cetane number=1.8+43.8(CH₂/CH₃)−8.1(CH₂/CH₃)²+0.69(CH₂/CH₃)³, where CH₂/CH₃ is the ratio of the integrated methylene and methyl regions in the proton NMR, as defined above.

As used herein, the verb “comprise” as is used in this description and in the claims and its conjugations are used in its non-limiting sense to mean that items following the word are included, but items not specifically mentioned are not excluded.

As used herein, the term “a” or “an” refers to one or more of that entity. As such, the terms “a” (or “an”), “one or more” and “at least one” are used interchangeably herein. In addition, reference to “an element” by the indefinite article “a” or “an” does not exclude the possibility that more than one of the elements are present, unless the context clearly requires that there is one and only one of the elements.

As used herein, the phrase “derived from” refers to the origin or source.

As used herein the term “Petrooxy test” is a method for measuring the oxidation stability of a fuel sample, per ASTM D7545. The presence of unsaturation in a fuel in general promotes fuel degradation by atmospheric oxygen especially in the presence of certain metals and higher temperatures. Fuel samples exhibiting higher Petrooxy values are generally considered more desirable as it suggests higher oxidation stability.

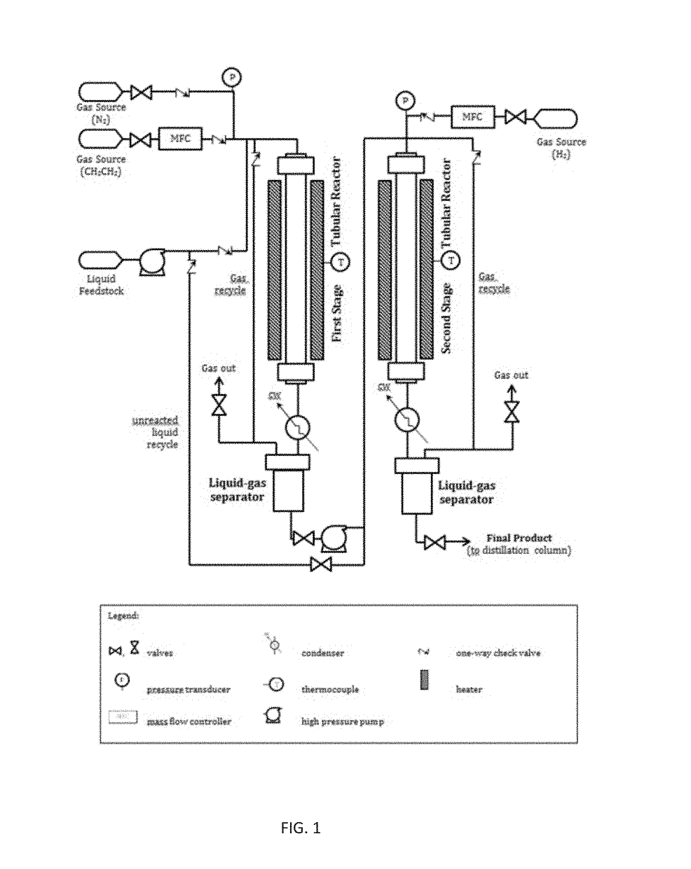

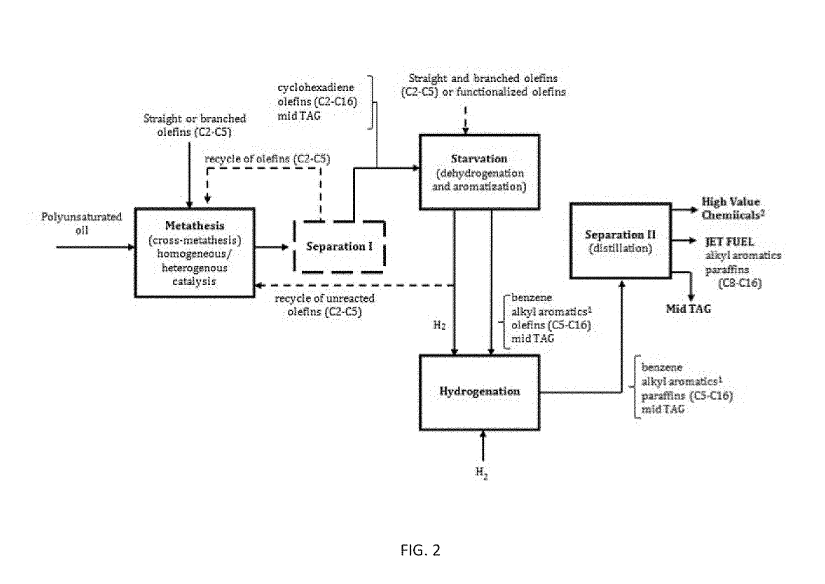

In embodiments of the present invention, as generally illustrated by the system of FIG. 1 and the diagram of FIG. 2, renewable transportation fuel is produced from renewable feedstocks. In particular embodiments, the renewable feedstock comprises unsaturated fatty acid glyceryl esters, and the transportation fuel comprises jet fuel that meets the specifications of ASTM D7566. In an embodiment, generating the transportation fuel comprises reacting a mixture of the renewable feedstock in the presence of a C₂-C₅ olefin and a metathesis catalyst to form a cross-metathesis product. The cross-metathesis product comprises C₄-C₁₇ olefins (cyclic and linear), medium-chain fatty glyceryl esters, and may additionally contain unreacted C₂-C₅ olefin. At least a portion of the metathesis product is dehydrogenated in the presence of a hydrogenation catalyst under hydrogen “starved” conditions (i.e. in the absence of hydrogen, or in an atmosphere containing a less than stellar geometric amount of hydrogen compared to the number of equivalents of carbon-carbon double bonds present) to form aromatics (e.g. from the cyclic olefins formed during the cross-metathesis reaction). The resulting dehydrogenated metathesis product is then hydrogenated in the presence of a hydrogenation catalyst and sufficient hydrogen to promote hydrogenation, thereby forming a hydrogenated mixture in which the medium-chain fatty glyceryl esters and olefins are converted to their corresponding saturated compounds, but without reducing the aromatics formed during dehydrogenation. The hydrogenated mixture, or a blend comprising at least 50% of the hydrogenated mixture and a fuel blendstock, meets the specifications of jet fuel (e.g., of Jet A, Jet A-1, Jet B, and/or any suitable fuel that generally conforms to ASTM D7566 specifications).

The renewable feedstock is sourced from plants or algae, and in various embodiments contains one or more plant oil selected from, but not limited to, flaxseed, rapeseed, camelina, soy, and palm oils. In most embodiments of the present invention, the plant oil is camelina oil and is sourced from the seed of the Camelina sativa plant for example. However, any plant oil having a sufficient level of unsaturated fatty acids can be used in the process of the present invention. A sufficient level of unsaturated fatty acids means 10-95% percent unsaturated fatty acids. Any suitable method for extracting or otherwise separating camelina oil from the seeds of the Camelina plant may be employed, such as solvent extraction, and/or mechanical extrusion processes such as cold pressing or hot pressing. In one embodiment, the feedstock comprises camelina oil that contains a 10-12% saturated component comprising palmitic and stearic acids, a 37-40% monounsaturated component that comprise oleic and eocasanoic acid, and a 48-50% polyunsaturated component that is primarily composed of linoleic, linolenic and docasatrienoic acid, respectively.

In most embodiments of the present invention, the unsaturated plant oil (e.g., Camelina oil) is subjected to cross-metathesis with a C₂-C₅ olefin. In other embodiments, some level of self-metathesis of the Camelina oil can occur, provided there is sufficient cross-metathesis to provide sufficient levels of cyclic olefin precursors to form approximately 5-12% aromatics. Cross-metathesis results in the formation of a metathesis product that includes medium-chain fatty glyceryl esters, acyclic olefins, cyclic olefins, and may further include unreacted C₂-C₅ olefins.

The cross-metathesis reaction can be catalyzed by one or more metathesis catalysts. Typically, metathesis catalysts are homogeneous, and therefore must be removed prior to successive reaction steps such as dehydrogenation. A non-limiting list of suitable metathesis catalysts include benxylidene-bis(tricyclohexylphosphine)dichlororuthenium (or Grubbs First Generation catalyst), (1,3-bis(2,4,6-trimethylphenyl)-2-imidazolidinylidene)dichloro(pheylmethylene) (tricyclohyxylphospine) ruthenium (or Grubbs Second Generation catalyst), bis(tricyclohyxylphosphine)isopentenylidene ruthenium dichloride (or Grubbs catalyst 801), 1,3-Bis-(2,4,6-trimethylphenyl)-2-imidazolidinylidene)dichloro(o-isopropoxyphylmethylene) ruthenium (or Hoveyda-Grubbs Catalyst 2nd Generation catalyst), dichloro[1,3-bis(2-methylphenyl)-2-imidazolidinylidene](2-isopropoxyphenylmethylene) ruthenium(II) (or Stewart-Grubbs catalyst).

The present inventors have found that heterogeneous metathesis catalysts can also be employed. Heterogeneous metathesis catalysts are advantageous in that they are readily separated from the metathesis products. For example, an appropriate feedstock, in the vapor or liquid phase, can be contacted with a solid-phase heterogeneous metathesis catalyst (e.g. by flowing the feedstock through a tubular reactor or column containing a fixed bed of the heterogeneous metathesis catalyst), thereby forming metathesis products in the vapor phase, which is easily separated from the catalyst by known methods. For example, ruthenium-based catalyst may be supported on solid media, such as bleaching clay (e.g. Oil-dri's Pure Flo, or Perform®). Suitable solid supports that may be used are mesoporous alumina, mesoporous silica and aluminasilicate minerals. The impregnation of the heterogeneous catalyst on the solid media may be carried out by preparing a slurry of the solid media with toluene containing the catalyst in an atmosphere of nitrogen, followed by evaporation of the solvent at 30° C. After metathesis, the adsorbed catalyst may be easily separated from the metathesis products and recycled. In an embodiment, no refining of the adsorbed catalyst is required due to its impregnation in the bleaching clay. When a homogeneous catalyst is used for metathesis, it is removed from the metathesis product, through adsorption with bleaching clay for example. Advantageously, removal of the catalyst prevents further metathesis, and particularly self-metathesis, during further processing.

In an embodiment, metathesis is carried out at temperatures between about 20°−50° C. (e.g. about 20, 30, 40, 50° C., including all ranges and subranges therebetween) when a homogeneous catalyst is used, and at temperatures between about 20°−80° C. (e.g. about 20, 30, 40, 50, 60, 70, 80° C., including all ranges and subranges therebetween) when a heterogeneous catalyst is used. Metathesis is carried out at a pressure between approximately 15-800 psi (e.g., about 15, 20, 30, 40, 50, 66, 70, 80, 90, 100, 200, 300, 400, 500, 600, 700, 800 psi, including all ranges and subranges therebetween) in an inert atmosphere, such as a nitrogen atmosphere. The metathesis reaction may be carried out in a batch or continuous reactor. FIG. 1 illustrates a First Stage tubular continuous reactor in an exemplary embodiment of a system of the invention for carrying out cross-metathesis of the feedstock with ethylene. Excess, unused ethylene is recycled back to the First Stage reactor after separation from the liquid metathesis products in a liquid-gas separator, thereby preventing wastage.

Temperature, pressure, flow rates of liquid and gases for each tubular reactor in FIG. 1 may be monitored via thermocouples, pressure transducers, and mass flow meters/controllers, respectively. A liquid sensor designed for high pressure applications and a solenoid valve may be installed in the first liquid-gas separator to maintain the liquid level at the separator, so that no excess ethylene flows along with the intermediate products into the second tubular reactor. All of the information is recorded and plotted in a computer using a central process control unit. This control unit has the capability to automatically control temperature and flow rates for each tubular reactor according to the operator's set values. For safety purposes, the operator is able to set temperature and pressure safety limits different from the desired set values using a computer of which the reactor can operate; and the control unit can automatically shut down the reactor system once one of the limits are reached.

In another embodiment, the metathesis of the feedstock results in a metathesis product that includes medium-chain fatty glyceryl esters, acyclic olefins, cyclic olefins, and optionally unreacted C₂-C₅ olefins. For example, cross-metathesis of camelina oil feedstock (with an exemplary composition as stated above) and ethylene yields one or more of 1-decene, 1-dodecene, 1-butene, 1,4-pentadiene, 1,4-heptene, 1,4-heptadiene, 1,4,7-octatriene, 1-octene and 4-decene. Ring closure metathesis of 1,4,7-octatriene may further desirably provide 1,4-cyclohexadiene. In an embodiment, the saturated component of the camelina feedstock remains substantially intact and bounded to glycerin. In an embodiment, the unsaturated components undergo metathesis, leading to the formation of decenoic acid moieties with the carbon-carbon double bond located at terminal carbon. The overall yield of metathesis products is about 50% or greater, and preferably about 70% or greater. In an embodiment, the 1,4-cyclohexadiene comprises about 29% of the metathesis products, and the medium-chain fatty glyceryl esters comprise about 60% of the metathesis products. Metathesis thus can comprise ethenolysis and isomerization.

In one embodiment, cross-metathesis of camelina oil feedstock (with an exemplary composition as stated above) and propylene yields a mixture of olefins comprising olefins with less than nine carbon atoms and olefins containing more than nine carbon atoms. For example, in one embodiment, cross-metathesis of camelina oil feedstock and propylene yields a mixture of C₉-C₁₃ olefins and olefins with less than C₉ atoms. C₉-C₁₃ olefins that are obtained by cross-metathesis of camelina oil and propylene include, but are not limited to, nonene, decenes such as 1-decene, undecenes, dodecenes, tridecenes and their isomers. Olefins with less than 9 carbon atoms that may be obtained by cross-metathesis of camelina oil and propylene include, but are not limited to, 1,4-cyclohexadiene, 2,4-hexadiene, 1-heptene, 2-octene, 3-octene, cyclooctene and/or their isomers. Exemplary yields of C₉-C₁₃ olefins and olefins with <C9 atoms obtained by metathesis of camelina oil and propylene are shown in Example 7.

In an embodiment, the metathesis product is dehydrogenated followed by hydrogenation to obtain a hydrocarbon fuel. In another embodiment, the metathesis product is separated or isolated, for example, by distillation to obtain a fraction containing C₉-C₁₃ olefins and a fraction containing olefins with less than C9 atoms. The fraction containing C₉-C₁₃ olefins can be further processed to obtain hydrocarbon fuel whereas the fraction containing olefins with less than C9 atoms can be processed to obtain a mixture of bicyclic hydrocarbons that may be used as high density aviation fuel.

In embodiments of the present invention, the metathesis products are dehydrogenated in the presence of a hydrogenation catalyst to form a dehydrogenated metathesis product comprising medium-chain fatty glyceryl esters, acyclic olefins, cyclic olefins, aromatics, and may also contains unreacted C₂-C₅ olefins. In an embodiment, dehydrogenation occurs in the absence of hydrogen. In an additional or alternative embodiment, dehydrogenation is carried out with substantially less than a stoichiometric amount of hydrogen gas relative to the amount of unsaturated bonds in the metathesis product. For example, “substantially less than the still geometric amount” of hydrogen can be less than 50% (on an equivalent basis) of the amount of unsaturated bonds in the metathesis product, less than 40%, less than 30%, less than 20%, less than 10%, including all ranges and separate is there between. Suitable examples of dehydrogenation catalysts include, but are not limited to, aluminum-nickel, Raney nickel, nickel on carbon, nickel on alumina, ruthenium oxide on alumina, platinum on carbon, and platinum on alumina.

Advantageously, dehydrogenation results in almost 100% conversion of the 1,4-cyclohexadiene of the metathesis products into benzene via aromatization. As illustrated in FIG. 2, the unreacted C₂-C₅ olefins may be recycled back into the metathesis step (First Stage reactor) to promote self and/or cross metathesis of these compounds to afford olefins with chain lengths up to C₈.

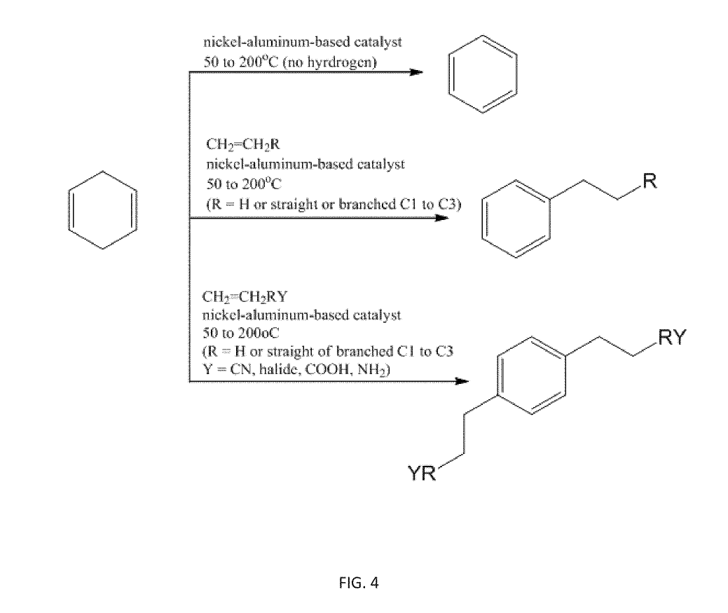

In an embodiment, dehydrogenation is carried out at temperatures between about 60°-300° C. (e.g., about 60, 70, 80, 90, 100, 110, 120, 130, 140, 150, 160, 170, 180, 190, 200, 210, 220, 230, 240, 250, 260, 270, 280, 290, or about 300° C., including all ranges and subranges therebetween), and at a pressure between approximately 50-1500 psi (e.g. about 50, 60, 70, 80, 90, 100, 200, 300, 400, 500, 600, 700, 800, 900, 1000, 1100, 1200, 1300, 1400, or about 1500 psi, including all ranges and subranges therebetween) in an inert (e.g. nitrogen) or other atmosphere. In one embodiment a Raney Nickel catalyst is used, and the dehydrogenation is carried out between about 60°−100° C. and at about 15-90 psi to effect selective aromatization of 1,3,7 octatriene and 1,4 cyclohexadiene components of the metathesis products to ethyl benzene and benzene, respectively. In an additional or alternative embodiment, temperatures of 100°-300° C. might be employed, which favor production of ethylbenzene over benzene. As best illustrated in FIG. 4, functionalized ethylbenzene can also be produced containing cyano group (—CN), halide (X), carboxylic acid (—COOH), or amino group (—NH₂) in embodiments of the invention during the dehydrogenation process by introduction of gaseous olefins or substituted olefins over nickel-aluminum-based catalyst at 80° C., or generally between 50°−200° C.).

In embodiments of the present invention, the dehydrogenation products are hydrogenated in the presence of hydrogen, preferably in the same reactor and using the same hydrogenation catalyst as that used for the dehydrogenation. Hydrogenation yields a hydrogenated mixture comprising medium-chain saturated fatty glyceryl esters, acyclic and cyclic saturated hydrocarbons, and aromatics. Hydrogenation is carried out with hydrogen gas in a amount sufficient to reduce unsaturated bonds in the dehydrogenation/aromatization product, thereby forming a saturated product. The hydrogenation conditions used maintain the integrity of the aromatics and glyceryl ester bonds of the fatty glyceryl esters generated during dehydrogenation, while converting unreacted alkenes into saturated hydrocarbons. The hydrogen employed during hydrogenation may be provided by an external source, or may be recycled from hydrogen generated during the dehydrogenation step.

FIG. 1 illustrates a Second Stage reactor for carrying out the dehydrogenation and hydrogenation processes, although any number of reactors, one for each of the dehydrogenation and hydrogenation processes for example, are possible within the scope of the invention. A separate mass flow controller monitors and controls the amount of hydrogen gas entering the reactor to achieve optimum dehydrogenation and hydrogenation. A liquid-gas separator separates excess hydrogen from the hydrogenated mixture and recycles it to the Second Stage reactor.

In some embodiments, the metathesis reaction rate is slower than the dehydrogenation and hydrogenation reaction rates, and hence the First Stage reactor has a longer reactor tube than the Second Stage reactor to maintain constant flow rate. A recycle line may be employed that returns unreacted products back to the First Stage reactor. Recycling ensures that the feedstock achieves maximum conversion while maintaining a continuous flow operation. Process optimization and tuning of the system of FIG. 1 can be easily achieved, by changing a flow rate ratio of recycle and outflow of products to the Second Stage reactor for example. In an embodiment, pressures of about 70-1500 psi (for example about 70, about 80, about 90, about 100, about 200, about 300, about 400, about 500, about 600, about 700, about 800, about 900, about 1000, about 1100, about 1200, about 1300, about 1400, or about 1500 psi, including all ranges and subranges therebetween) are used during hydrogenation when higher hydrogenation rates are desirable.

In an embodiment, dehydrogenation and hydrogenation are carried out in the presence of a nickel-aluminum catalyst. Dehydrogenation occurs for about one hour, and then hydrogen is supplied at about 70 psi. The resulting hydrogenated mixture comprising at least about 25% aromatics. In alternative embodiments, the dehydrogenation reaction can be carried out continuously under partial conversion conditions, with the partially reactant product recycled back to the dehydrogenation reaction until essentially total conversion is achieved. Similarly, the hydrogenation reaction can be carried out under partial conversion conditions, and the product recycled back to the hydrogenation reaction until essentially total conversion is achieved.

Optionally, the _{hydrogenated} mixture is separated or isolated into fractions. In most embodiments, distillation is employed for the isolation, though other well known techniques such as ultrafiltration are within the scope of the invention. Any criteria may be used for establishing the boundaries of the fractions to be extracted from the distillation process.

In most embodiments, at least one of the fractions meets certain ASTM standards. For example, a fraction comprising at least 25% aromatics and is acceptable as jet fuel (e.g., as Jet A, Jet A-1, Jet B, and/or the like), or for blending with jet fuel per ASTM standard D7566. Fractions with higher freeze points and higher cetane numbers are acceptable per ASTM Standard D975. Other fractions with a high octane number might be acceptable for blending with gasoline fuel (including aviation gasoline), but not jet or diesel fuel. FIG. 2 illustrates a non-limiting embodiment of a system generating a multitude of products. When ethylbenzene and/or functionalized ethylbenzene are produced during the dehydrogenation process, a fraction of these components may be separated for use in polymer and other industries (see FIG. 4).

It is to be understood that two or more of the fractions might be recombined after distillation. It is also to be understood that two or more of the fractions might be distilled in combination, if possible. Optionally, any of the fractions may be further hydrogenated to remove all traces of olefins. When the jet and/or diesel biofuels are derived from renewable feedstock in this manner, the biofuels are renewable.

Among other operations, another fraction comprising the medium-chain saturated fatty glyceryl esters obtained from distillation are of greater value than the starting feedstock, and find application in the biodiesel, surfactant, and other petrochemical/oleochemical industries.

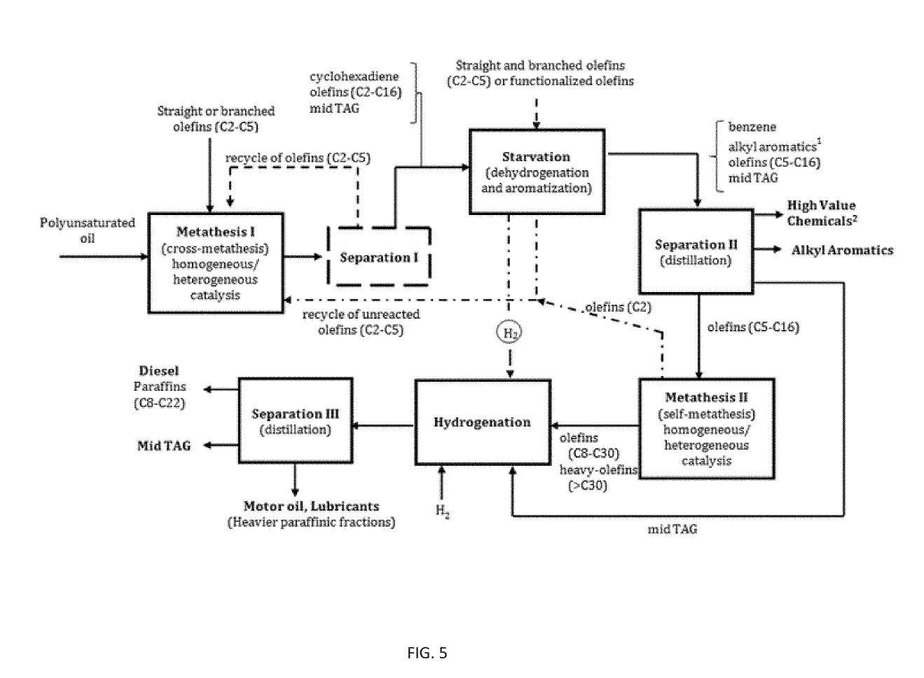

FIG. 5 illustrates another process of the present invention. The process of FIG. 5 has several identical or similar steps with the process of FIG. 2 described above, thus unless stated otherwise, various aspects of the process of FIG. 5 function similarly to that of other embodiments. For example, the metathesis I, separation I, and dehydrogenation step in FIG. 5 may be similar to the metathesis, separation I, and dehydrogenation step in FIG. 2, respectively.

FIG. 5 illustrates an additional distillation (illustrated as separation II) step that might be run after dehydrogenation and prior to hydrogenation. As already discussed, the dehydrogenated mixture contains aromatics such as, may contain alkyl aromatics such as ethyl benzene, and (when functionalized olefins are employed during dehydrogenation), may also contain functionalized aromatics. The dehydrogenated mixture also contains medium-chain fatty glyceryl esters as discussed. These components may be selectively removed, via distillation for example, resulting in a remaining olefin fraction of low molecular weight (C5-C16). This olefin fraction then undergoes self-metathesis (illustrated as metathesis II) to generate higher molecular weight olefins, preferably in the C₈₋₃₀ range, or higher. The higher molecular weight olefins are then subject to hydrogenation as described earlier. The medium-chain fatty glyceryl esters obtained from the separation II step are hydrogenated as already discussed. In an embodiment, metathesis II occurs in the same or different reactor as metathesis I. Additionally, any C₂ olefins generated during metathesis II may be recycled for use during metathesis I.

Still referring to FIG. 5, distillation subsequent to hydrogenation in this embodiment (illustrated as Separation III) results in separation of a C₈-C₂₂ fraction, either by itself or as a combination of several fractions that meets ASTM D975 standards of diesel fuel. The saturated medium-chain fatty glyceryl esters are also recovered at this step as a separate fraction, as is a fraction of other high molecular weight (>C₂₂) components suitable for use as motor oil and as lubricant, either alone or in a blend. Advantageously, this approach eliminates any limited possibility of hydrogenation of the aromatics, which are separated beforehand.

In another embodiment, C₉-C₁₃ olefins and olefins containing less than C9 atoms are separated after metathesis, and the fraction containing olefins with less than C9 atoms is converted into a mixture of bicyclic and polycyclic hydrocarbons. For example, in one embodiment, the fraction containing olefins with <C9 atoms is subjected to a cycloaddition reaction, such as a [2+2] cycloaddition, and hydrogen, to obtain a mixture of cyclic hydrocarbons containing two or more fused rings. Prior to the cycloaddition reaction, the fraction containing olefins with <C9 atoms may be contacted with an isomerization reagent to convert 1,4-cyclohexadiene to 1,3-cyclohexadiene. For instance, in one embodiment, 1-heptene, 2-octene, 3-octene and cyclooctene present in the fraction containing olefins with <C9 atoms may react with 1,3-cyclohexadiene (obtained by isomerization of 1,4-cyclohexadiene) to form bicyclic and polycyclic hydrocarbons containing a four-membered ring fused to a six-membered ring as shown in Example 7. This fusion of a four-membered ring to a six-membered ring adds steric strain similar to that present in JP-10 hydrocarbons that are used in rocket fuel. The added steric strain provided by the bicyclic and polycyclic hydrocarbons obtained by the cycloaddition reaction will release more thermal energy per unit volume or weight, and can be used as a high energy density aviation fuel.

Isomerization reagents that can be used in a cycloaddition reaction include 1,4-benzoquinone, NaBAr^{f}₄ (where Ar^{f} stands for 3,5-(CF₃)₂C₆H₃)), and Ni(COD)₂ (Nickel bis-cyclooctadiene). In a particular embodiment, the isomerization reagent is 1,4-benzoquinone. The isomerization reagent, such as Ni(COD)₂, may be used in the presence of a ligand, such as an Ipr ligand (where Ipr stands for 1,3-bis(2,6-diisopropylphenyl)imidazole-2-ylidene).

The cycloaddition reaction is preferably carried out in the presence of a cyclization catalyst. The cyclization catalyst that may be used include ruthenium photocatalyst, such as ruthenium (II) bipyrimidine (Ru(bpm)₃⁺²), and carbonylchlorohydrotris(triphenylphosphine)ruthenium (RuHCl(CO)(PPH₃)₃).

The present invention also provides metathesis catalysts and methods for preparing them. The metathesis catalysts of the invention can be used in the metathesis reactions disclosed herein or other metathesis reactions known in the art. In various embodiments, the present invention provides a heterogeneous metathesis catalyst comprising a ruthenium complex immobilized on silica. In other embodiments, the present invention provides a heterogeneous metathesis catalyst comprising a ruthenium complex linked to a polymeric ligand. In still other embodiments, the heterogeneous metathesis catalyst comprises a polymer-linked ruthenium complex immobilized on silica. The ruthenium complexes of the heterogeneous metathesis catalysts of the present invention are preferably Grubbs catalysts disclosed herein.

In one embodiment, a ruthenium catalyst can be grafted on the surface of silica particles by covalently linking an azide functional group of silica and a N-heterocyclic carbene (NHC) ligand of a ruthenium complex to obtain a Grubbs catalyst shown below:

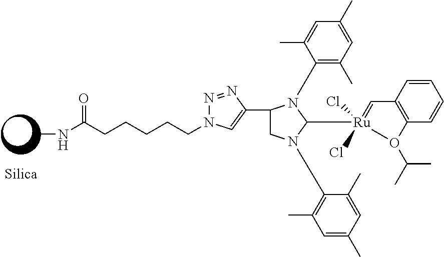

In another embodiment, commercially available silica can be functionalized to contain azide functional groups using 6-bromohehanoic acid as shown in the synthesis scheme below:

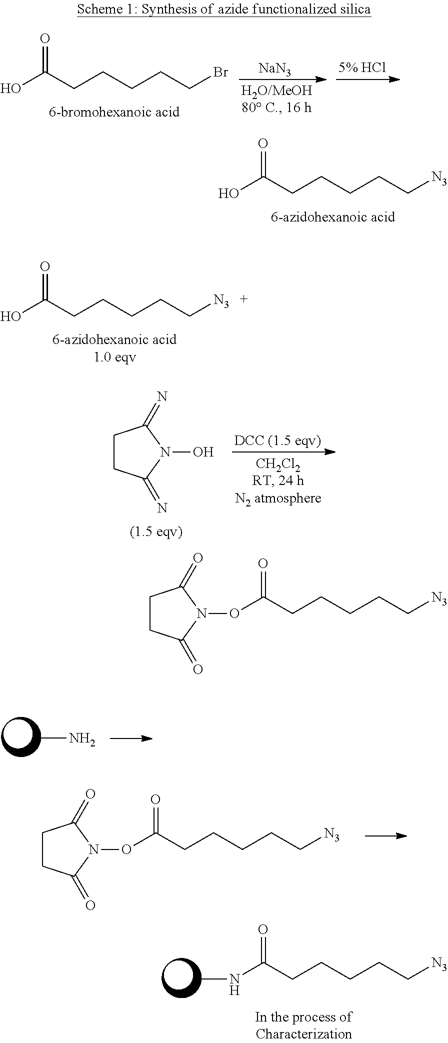

In another embodiment, a NHC ligand of a ruthenium catalytic moiety can be functionalized to contain alkyne functional groups. For example, in one embodiment, an alkyne functional group can be incorporated by reacting a NHC ligand such as N, N′-(2,4,6-trimethylphenyl)-1,2-ethylenediamine with propargyl magnesium bromide (prepared in situ from propargyl bromide) to give N, N′-(2,4,6-trimethylphenyl)-1-(1-propyne)-1,2-ethylenediamine (2) as shown in Equation 1 below:

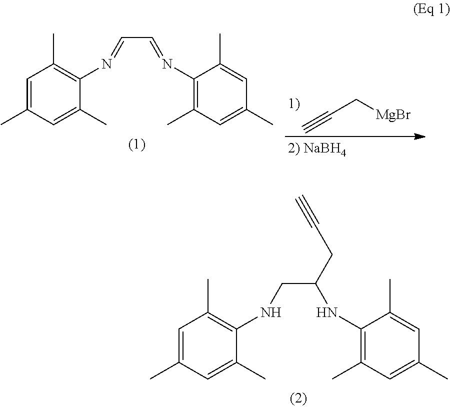

In another embodiment, an alkyne functional group can be incorporated into a NHC ligand by blocking the side reactivity of terminal alkynyl hydrogen using TMS protected propargyl magnesium bromide as shown in Scheme 2 below. After the synthesis of N, N′-(2,4,6-trimethylphenyl)-1-(1-propyne)-1,2-ethylenediamine (2), the ligand is cyclized to form NHC-alkyne. The cyclized NHC-ligand can be clicked covalently with an azide of the silica particle. The ruthenium complex can be added on the NHC ligand of the silica particle by treating with KHMDS (potassium hexamethyl disilazide or potassium bis(trimethylsilyl)amide) as shown in Scheme 2 to provide a heterogeneous metathesis catalyst according to one embodiment of the invention.

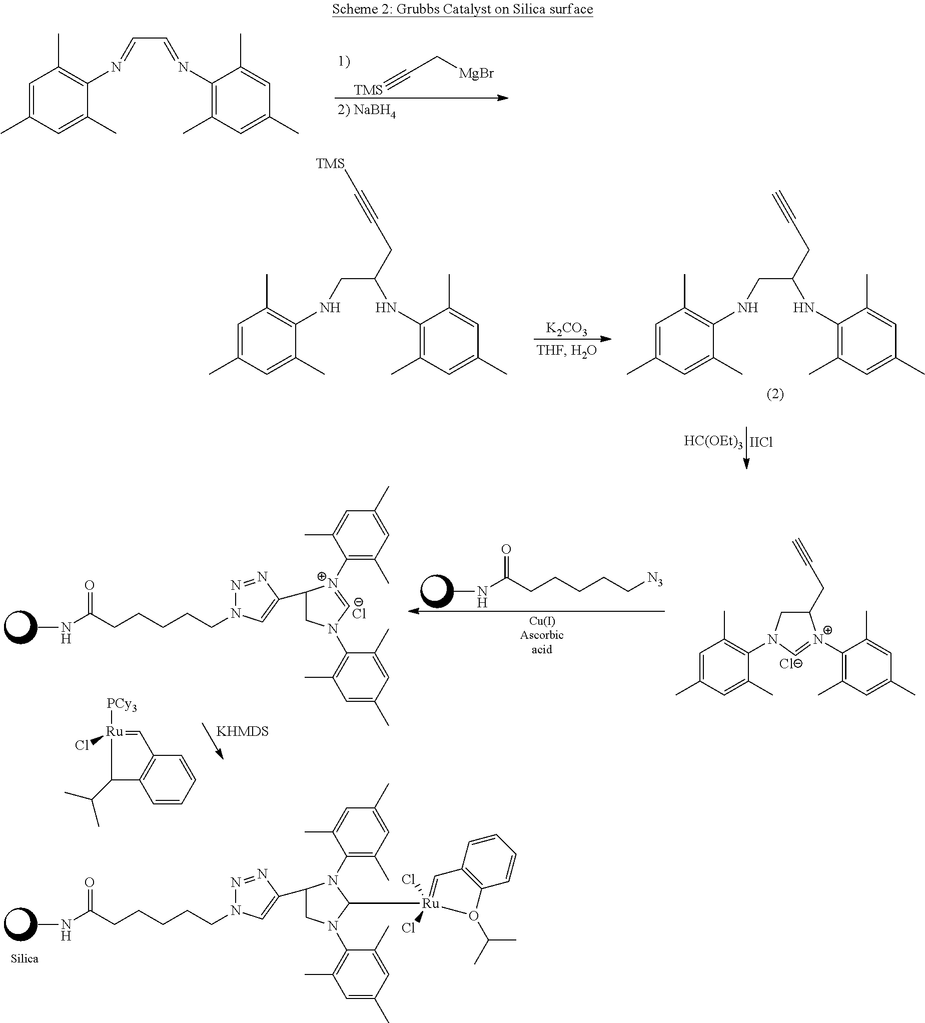

In another embodiment, a NHC ligand of a ruthenium catalytic moiety is functionalized to contain terminal vinyl groups. Molecules containing terminal alkene groups, such as vinyl groups, can undergo atom transfer radical polymerization (ATRP) reaction to form a polymer of the molecule. Accordingly, a NHC ligand with terminal vinyl group can undergo a polymeric reaction when charged with AIBN (azobisisobutylonitrile) to form a polymer of the NHC ligand. The polymerization of the NHC ligand is carried out at a temperature of 90-110° C., more preferably at or around 100° C. The NHC ligand polymer can be loaded with a catalytic ruthenium complex to give a polymeric Grubbs catalyst. An example of a polymeric Grubbs catalyst according to the invention is shown below:

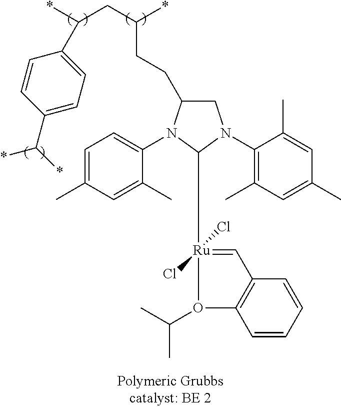

An alkene-functionalized NHC ligand can be synthesized, for example, by reacting ally magnesium bromide with a NHC ligand, such as bis-(2,4,6-trimethylphenyl)-1,2-ethylenediamine, followed by cyclization with triethyl orthoformate as shown in Scheme 3:

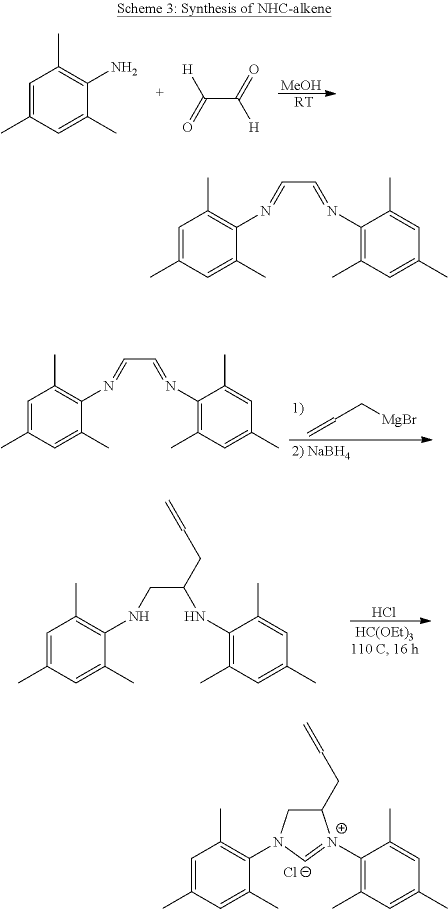

A polymer of an alkene-functionalized NHC ligand can be synthesized as shown in Scheme 4. For example, bis-(2,4,6-trimethylphenyl)-1-allyl-1,2-ethylenediamine can be directly converted to a polymer with AIBN followed by cyclization to form a NHC polymer. Alternatively bis-(2,4,6-trimethylphenyl)-1-allyl-1,2-ethylenediamine can be first cyclized and then polymerized with AIBN. The ruthenium catalytic complex is then incorporated on the NHC polymer in the presence of KHMDS as shown in Scheme 4.

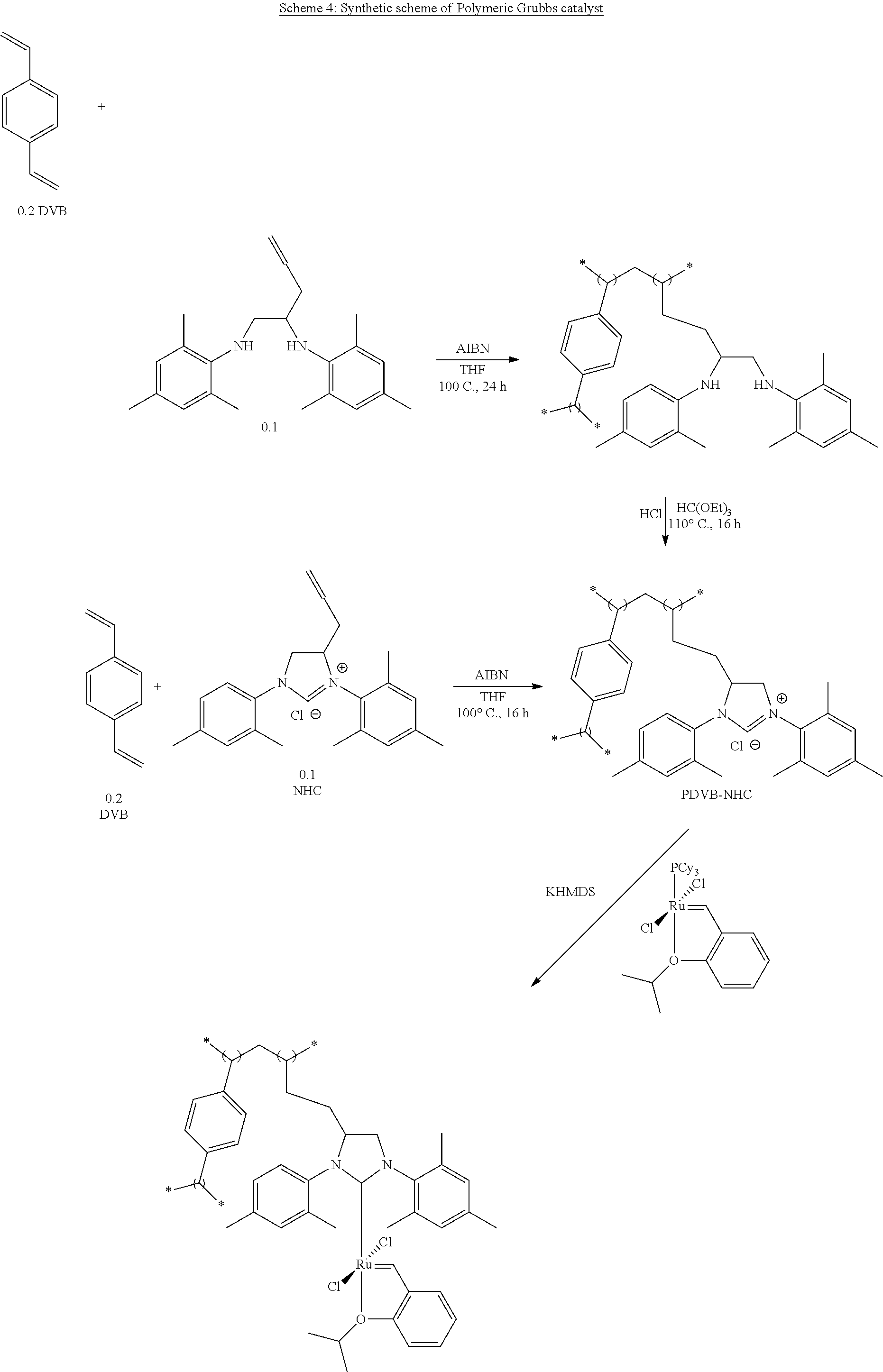

In another embodiment, the invention provides a polymeric Grubbs catalyst supported on silica. An example of a silica supported polymeric Grubbs catalyst according to the invention is shown below:

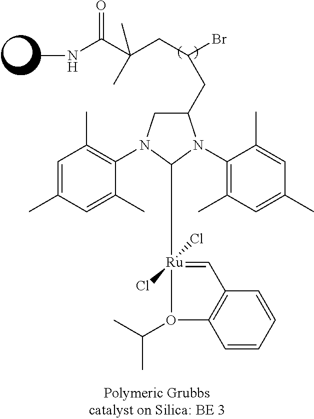

In still another embodiment, a silica-supported polymeric Grubbs catalyst according to the invention can be synthesized as shown in Scheme 5. Specifically, a NHC ligand, such as bis-(2,4,6-trimethylphenyl)-1-allyl-1,2-ethylenediamine, can be polymerized using an ATRP reaction. For example, bis-(2,4,6-trimethylphenyl)-1-allyl-1,2-ethylenediamine can be polymerized in the presence of 2-bromoisobutyryl bromide. The polymerization is initiated in the presence of bromoisobutyryl bromide by abstracting bromine radical. The terminal acyl groups of the synthesized NHC polymer can be used to graft the polymer on the silica particle by treating it with amine-functionalized silica. The ruthenium catalytic complex is incorporated on the NHC polymer by treating with KHMDS.

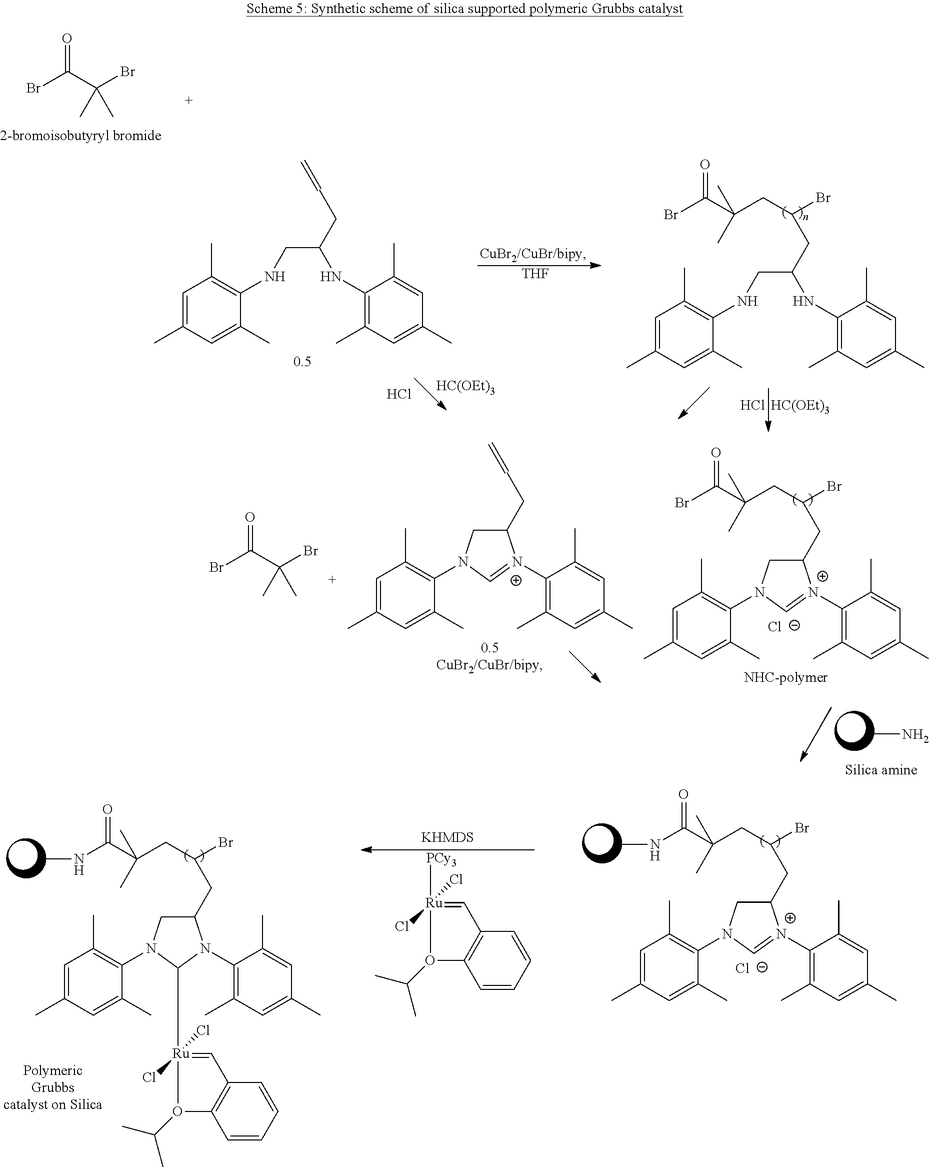

The heterogeneous supported metathesis catalysts described herein can be charged into a continuous reactor into which is fed a feedstock of unsaturated fatty acid glycerol esters (e.g., any of the plant oils, such as camelina oil, disclosed herein) and propylene or ethylene, thereby forming olefins which upon catalytic hydrogenation produce transportation fuels or transportation fuel blend stocks. The by-products of metathesis reaction, such as olefins and medium-chain fatty acid glycerol esters, can be used for oleochemical productions and as a feed stock for polymer applications.

Although various embodiments have been described as having particular features and/or combinations of components, other embodiments are possible having any combination or sub-combination of any features and/or components from any of the embodiments described herein. The specific configurations of the various components can also be varied. For example, the size and specific shape of the various components can be different than the embodiments shown, while still providing the functions as described herein. Thus, the breadth and scope of the invention should not be limited by any of the above-described embodiments. The previous description of the embodiments is provided to enable any person skilled in the art to make or use the invention. While the invention has been particularly shown and described with reference to embodiments thereof, it will be understood by those skilled in the art that various changes in form and details may be made therein without departing from the spirit and scope of the invention.

### Examples

### Example 1

Various metathesis catalysts were characterized as summarized below. Typical metathesis reactions for characterizing these catalysts were carried out using a 500-ml high pressure reactor equipped with overhead stirring and temperature controller. Prior to loading the catalyst into the reactor, 0.15% of the catalyst was dissolved in 300 ml camelina oil. After purging the reactor with nitrogen, the metathesis reaction was then carried out at a range of temperature and pressure conditions (under ethylene gas) for each catalyst, for 4 hours, and with constant stirring. The reaction products were separated from the catalyst by adsorption with bleaching clay at room temperature. The slurry was then centrifuged and filtered to collect the purified metathesis products. Underivatized and derivatized products were analyzed by GC/MS to determine optimal conditions of temperature and pressure for each catalyst.

### Benxylidene-bis(tricyclohexylphosphine)dichlororuthenium (or Grubbs First Generation Catalyst)

Products: straight-chain paraffins (C₄-C₁₂) chain length as the major products), cyclic dienes, aromatics (benzene and ethyl benzene), middle-chain triglycerides (C₁₀-C₁₂ fatty acid moieties).

Yield and Selectivity: 50% by wt. yield with high selective to shorter-chain hydrocarbons, aromatics and middle-chain triglycerides (>90%).

Process Conditions of Alkene Metathesis: optimum at low temperature (20-50° C.) and low pressure (50-100 psi).

### (1,3-Bis(2,4,6-trimethylphenyl)-2-imidazolidinylidene)dichloro(pheylmethylene) (tricyclohyxylphospine) ruthenium (or Grubbs Second Generation Catalyst)

Products: Straight-chain paraffins (C₁₂-C₂₂) chain length as the major products), cyclic dienes, aromatics (benzene and ethyl benzene), middle-chain triglycerides (C₁₀-C₁₆ fatty acid moieties).

Yield and Selectivity: 70% by wt. yield with high selective to heavier hydrocarbons and middle-chain triglycerides (>90%).

Process Conditions of Alkene Metathesis: optimum at low temperature (20-50° C.) and low pressure (50-100 psi).

### Bis(tricyclohyxylphosphine)isopentenylidene ruthenium dichloride (or Grubbs catalyst 801)

Products: Straight-chain paraffins (C₁₂-C₂₂) chain length as the major products), cyclic dienes, aromatics (benzene and ethyl benzene), middle-chain triglycerides (C₁₀-C₁₆ fatty acid moieties).

Yield and Selectivity: 50% by wt. yield with high selective to heavier hydrocarbons and middle-chain triglycerides (>90%).

Process Conditions of Alkene Metathesis: Optimum at reaction pressures of greater than 600 psi.

### 1,3-Bis-(2,4,6-trimethylphenyl)-2-imidazolidinylidene)dichloro(o-isopropoxyphylmethylene) ruthenium (or Hoveyda-Grubbs Catalyst 2nd Generation Catalyst)

Products: Straight-chain paraffins (C12-C22) chain length as the major products), cyclic dienes, aromatics (benzene and ethyl benzene), middle-chain triglycerides (C₁₀-C₁₆ fatty acid moieties).

Yield and Selectivity: 70% by wt. yield with high selective to heavier hydrocarbons and middle-chain triglycerides (>90%).

Process Conditions of Alkene Metathesis: Optimum at reaction pressures of greater than 600 psi.

### Dichloro[1,3-bis(2-methylphenyl)-2-imidazolidinylidene](2-isopropoxyphenylmethylene) ruthenium(II) (or Stewart-Grubbs Catalyst)

Products: Straight-chain paraffins (C₄-C₂₂), cyclic dienes, aromatics (benzene and ethyl benzene), middle-chain triglycerides (C₁₀-C₁₆ fatty acid moieties).

Yield and Selectivity: 50% by wt. yield and produces equal amounts of light and heavy hydrocarbons.

Process Conditions of Alkene Metathesis: optimum at low temperature (20-50° C.) and low pressure (50-100 psi).

### Ruthenium[1,3-bis-(2,4,6-trimethylphenyl)-2-imidazolidinylidene]dichloro(3-methyl-2-butenylidene)(tricyclohexylphospine) (or C827 Grubbs Catalyst)

Products: Straight-chain paraffins (C₄-C₂₂), cyclic dienes, aromatics (benzene and ethyl benzene), middle-chain triglycerides (C₁₀-C₁₆ fatty acid moieties).

Yield and Selectivity: 80% by wt. yield with high selectivity for shorter-chain hydrocarbons, medium-chain hydrocarbons, aromatics, and middle-chain triglycerides.

Process Conditions of Alkene Metathesis: optimum at low temperature (20-80° C.) and low pressure (20-100 psi).

### Example 2

Various dehydrogenation/hydrogenation catalysts were characterized as summarized below.

### Aluminum-Nickel and Raney Nickel Catalysts

Reactions: dehydrogenation of cyclic dienes to benzene; hydrogenation of α-olefins to straight-chain paraffins without hydrogenating aromatics such as benzene.

Process Conditions during Dehydrogenation and Hydrogenation: optimum at low temperature (60-100° C.) and low pressure (50-90 psi); selective aromatization of 1,3,7 octatriene and 1,4 cyclohexadiene to ethyl benzene and benzene, respectively, achieved by starving the reaction with hydrogen.

### Nickel on Carbon and Nickel on Alumina Catalysts

Reactions: dehydrogenation of cyclic dienes to benzene; aromatization of 1,3,7-octatriene to ethyl benzene; hydrogenation of α-olefins and polyunsaturated hydrocarbons to straight-chain paraffins; hydrogenation of unsaturated triglycerides to saturated triglycerides.

Process Conditions during Dehydrogenation and Hydrogenation: optimum at high temperatures (200-300° C.) and moderate pressures (500-1500 psi); aromatization of 1,3,7 octatriene and 1,4 cyclohexadiene to ethyl benzene and benzene, respectively, occurs in the presence of hydrogen (optimum at 100-500 psi).

### Ruthenium Oxide on Alumina Catalyst

Reactions: dehydrogenation of cyclic dienes to benzene; aromatization of 1,3,7-octatriene to ethyl benzene; hydrogenation of α-olefins and polyunsaturated hydrocarbons to straight-chain paraffins; hydrogenation of unsaturated triglycerides to saturated triglycerides.

Process Conditions during Aromatization and Hydrogenation: optimum at high temperatures (200-300° C.) and moderate pressures (500-1500 psi); aromatization of 1,3,7 octatriene and 1,4 cyclohexadiene to ethyl benzene and benzene, respectively, occurs in the presence of hydrogen (optimum at 100-500 psi).

### Platinum on Carbon and Platinum on Alumina Catalysts

Expected Reactions: dehydrogenation of cyclic dienes to benzene; aromatization of 1,3,7-octatriene to ethyl benzene; hydrogenation of α-olefins and polyunsaturated hydrocarbons to straight-chain paraffins; hydrogenation of unsaturated triglycerides to saturated triglycerides.

Process Conditions during Aromatization and Hydrogenation: optimum at high temperatures (200-300° C.) and moderate pressures (500-1500 psi); aromatization of 1,3,7 octatriene and 1,4 cyclohexadiene to ethyl benzene and benzene, respectively, occurs in the presence of hydrogen (optimum at 100-500 psi).

### Supported Copper Catalysts

Reactions: dehydrogenation of cyclic dienes to benzene; aromatization of 1,3,7-octatriene to ethyl benzene; hydrogenation of α-olefins and polyunsaturated hydrocarbons to straight-chain paraffins; hydrogenation of unsaturated triglycerides to saturated triglycerides.

Process Conditions during Dehydrogenation and Hydrogenation: optimum at high temperatures (100-300° C.) and moderate pressures (50-500 psi); aromatization of 1,3,7 octatriene and 1,4 cyclohexadiene to ethyl benzene and benzene, respectively, occurs in the presence of hydrogen (optimum at 50-100 psi).

### Example 3

To better understand the reaction conditions that promote the formation of benzene during dehydrogenation and hydrogenation, model compounds were tested. Pure 1,4-cylcohexadiene in the presence and absence of 1-dodecene were used in starvation and hydrogenation processes using the nickel-aluminum-based catalyst and heptane as a solvent at 80° C. Successive starvation and hydrogenation of 1,4-cyclohexadiene in the presence of 1-dodecene afforded benzene and dodecane as major products with minor amounts of 4-dodecene and 5-dodecene resulted from the isomerization of 1-dodecene. As expected when these reactions were conducted in the absence of 1-dodecene, the conversion of 1,4-cyclohexadiene into benzene via aromatization was observed; hydrogenation to give cyclohexane was essentially undetectable.

Further experiments proved that the aromatization of 1,4-cyclohexadiene to afford benzene is possible during starvation, and not during hydrogenation. When 1,4-cyclohexadiene was subject to starvation in the presence of 1-dodecene, cyclohexane was undetectable in the product, giving almost 100% conversion of 1,4-cyclohexadiene into benzene. Since hydrogen is absent during starvation, formation of dodecane from 1-dodecene was not observed but rather, 20% of this compound had undergone isomerization to give 4-dodecene and 5-dodecene. Direct hydrogenation of 1,4-cylcohexadiene in the presence of 1-dodecene did not afford benzene; quantitative conversion of 1,4-cyclohexadiene to cyclohexane was observed. Moreover, direct hydrogenation of 1-dodecene was observed with minimal isomerization to give 4-dodecene and 5-dodecene. These clearly showed that 1,4-cyclohexadiene may undergo aromatization into benzene under relatively mild condition (80° C.) using the nickel-aluminum-based catalyst in the absence of hydrogen gas.

TABLE 1
Conversion and Selectivity to Benzene and Alkanes during Starvation and Hydrogenation
Reactions.

| | Successive | Successive | | |
|---|---|---|---|---|
| | Starvation and | Starvation and | | |
| | Hydrogenation | Hydrogenation | Starvation | Hydrogenation |
| | with | without | Only with | only with |
| MODEL COMPOUND | 1-dodecene | 1-dodecene | 1-dodecene | 1-dodecene |
| 1. 1,4-cyclohexadiene | | | | |
| Conversion, % wt | >99.9 | >99.9 | 88.9 | >99.9 |
| Aromatization | | | | |
| benzene | Major | Major | Major | Not detected |
| Hydrogenation | | | | |
| cyclohexane | Not detected | Not detected | Not detected | Major |
| 2. 1-dodecene | | | | |
| Conversion, % wt | >99.9 | — | 20.2 | >99.9 |
| Hydrogenation | | | | |
| dodecane | Major | — | Not detected | Major |
| Isomerization | | | | |
| 4-dodecene | Minor | — | Major | Minor |
| 5-dodecene | Minor | — | Major | Minor |

### Example 4

Vacuum Distillation:

The volatile fraction comprising aromatics was separated from the glycerin bound fatty acids by vacuum distillation. A clear colorless liquid was collected at 60-140° C. under vacuum mainly composed of aliphatic hydrocarbons with chain length ranging from C₆ to C₁₅. This fraction also contains up to 21% of aromatic hydrocarbon mainly composed of benzene and benzene substituted compounds. The residue, which is a clear yellow liquid, is a mixture of triglycerides mainly composed of middle chain fatty acids.

Some fuel properties of the neat distillate (100%) and 50/50 blend with commercial Jet A fuel are summarized in Tables 2 and 3.

The neat distillate (the “MSUN biojet fuel”) exhibited comparable cloud point, carbon residue and sulfur content with commercial Jet A fuel. It is on the other hand three times more stable against oxidation compared to commercial Jet A fuel as evidenced by longer petrooxy value.

The 50:50 blend of commercial Jet A fuel with the neat distillate exhibited higher cetane number and cetane index compared to neat Jet A fuel. The lower distillation temperature of the blends at T90, T95 and density compared to neat Jet A fuel suggests the presence of higher amounts of shorter chain hydrocarbons in the mixture. This could be addressed by further fractionation of the distillate into gasoline (including aviation gasoline) and jet fuel fraction to achieve the desired properties of the fuel for specific applications.

TABLE 2
Some properties of the neat distillate

| | ASTM | | MSUN |
|---|---|---|---|
| Fuel Property | Method | Jet-A Fule | Biojet Fuel |
| Cloud Point, ° C. | D2500 | <−32 | <−32 |
| Carbon residue, % | D4530 | 0 | 0 |
| Sulfur | D5453 | 2.05 | 1.97 |
| Petrooxy, hr.min.sec | D7545 | 1 hr.3 min.47 sec | 3 hr.0 min.29 sec |

TABLE 3
Some fuel properties of commercial Jet-A fuel and its 50/50 blend with
MSUN Biojet Fuel determined by IROX Diesel Analyzer

| | | 50/50 blend (Jet-A and |
|---|---|---|
| Fuel Property | Jet-A Fule | MSUN Biojet Fuel) |
| Cetane number | 44.0 | 53.9 |
| Cetane index | 37.5 | 61.7 |
| T90, ° C. | 341 | 213 |
| T95, ° C. | 371 | 223 |
| Density, g/m³ | 0.813 | 0.772 |

### Example 5. Typical Experimental Procedure and Analysis

a. Conversion/Synthesis.

Camelina oil was obtained from locally grown Camelina sativa seeds and the oil was extracted at Bio-Energy Center pressing facility. Hydrogen and ethylene gases with 99% purity were used in all of the experiments. Benzylidine-bis(tricyclohexylphospine)dichlororuthenium (catalyst [1]), also known as Grubbs first generation catalyst, and activated Raney nickel catalyst (catalyst [2]) were purchased from Sigma Aldrich (St. Louis, Mo.) and were used in (1) alkene metathesis and (2) aromatization (dehydrogenation) and hydrogenation reactions, respectively.

A 500 mL batch pressure reactor was used for conducting the experiments. The reactor is capable of handling up to 5000 psig of pressure and 350 □C of temperature, and equipped with a controller to regulate and monitor the operating temperature and agitation motor speed. A 1000 L high pressure syringe pump (Teledyne-Isco, Lincoln, Nebr.) was used to deliver ethylene and maintain the reactor's pressure.

Typical alkene metathesis of 300 g of camelina oil with ethylene was conducted in 500 mL batch pressure reactor equipped with overhead stirrer. Prior to reaction, 0.02 to 0.15% (by weight w.r.t. oil) of catalyst [1] were loaded in the reactor containing the oil. The reactor was then completely sealed and purged with nitrogen and then with ethylene gas through an inlet port. Using the high pressure syringe pump, a 70 psi of ethylene was maintained during the alkene metathesis reaction. Camelina oil was reacted with ethylene gas for 4 h and at 30° C. Upon the completion of the reaction, excess ethylene gas and non-condensable gases formed during the reaction were vented out. The liquid product with the dissolved catalyst [1] were collected and weighed. The catalyst was removed from the liquid product by adding 10% of Oil-Dri (Perform®) bleaching clay by weight of liquid product and mixing the slurry for 30 min. The slurry was then centrifuged at 1800 rpm for 10 min to separate the bleaching clay from the purified liquid product. The purified liquid product was then decanted to a container and weighed.

The second step involved simultaneous aromatization and hydrogenation reactions using catalyst [2]. Typically, 220 g of the collected purified liquid product from the first step was mixed with 3.5% by weight of catalyst to give slurry. The slurry was then loaded in the same reactor which was purged with nitrogen after completely sealing it. The reaction was conducted at atmospheric pressure and in a closed system for 1 h at 80° C. At this stage, aromatization reactions occur. Immediately after the reaction, hydrogen gas was supplied and maintained at 70 psi using a high pressure syringe pump and the reaction was continued for another 1 h at 80° C. At this stage of the process, hydrogenation of α-olefins and polyunsaturated olefins are occurred to afford mixture of paraffins (saturated hydrocarbons) leaving the aromatics intact.

After hydrogenation, the reactor was then cooled to room temperature and the excess hydrogen gas was then vented out. The liquid product was separated from the catalyst using a centrifuge. The refined liquid product was then distilled under vacuum to give volatile hydrocarbons (distillate) and clear yellow oily residue (triglycerides composed of middle-chain fatty acids). Typically, the cooling liquid of the condenser used in the distillation was at −5° C. to avoid losses of low boiling point components. The distillate and the residue were collected separately, weighed and analyzed.

b. FAME Derivatization for Fatty Acid Profile Analysis.

The oil fraction collected after vacuum distillation is converted into fatty acid methyl esters (FAME) for fatty acid profile analysis. Fifty grams of the middle chain triglycerides was mixed with 10 g of methanolic NaOH solution (0.3% by wt. NaOH in methanol). The derivatization reaction was conducted under reflux for 2 h at 60-65° C. with continuous stirring. After the reaction, 100 mL of hexane was added to the solution and was settled in a separatory funnel until two visible layers was formed. The glycerin layer was removed from the organic layer. The remaining solution was then washed with water three times. The solution was furthered dried by approximately adding 3-5 g of anhydrous Na₂SO₄ and mixture was stirred for 5 min. Na₂SO₄ was removed through filtration and hexane was evaporated from the final product. The final product was then analyzed via GC-MS.

c. Gas Chromatography-Mass Spectrometry (GC-MS) Analysis.

One microliter of the distillate fraction collected after vacuum distillation was injected into an Agilent 7890A gas chromatograph equipped with Agilent 5975C inert mass spectrometer with Triple-Axis Detector and HP-5MS gas chromatograph column. The inlet temperature was set to 250° C. The carrier gas was helium at a flow rate of 1.5 mL/min and a split injection ratio of 1:250. The temperature of the oven was initially set at 90° C. held for 2 min, increased to 250° C. at a rate of 9° C./min and maintained for 5 min.

The derivatized oil fraction collected after vacuum distillation was dissolved in heptane. The diluted samples were injected into the same GC-MS described above. Using the same inlet temperature, the flow rate of the carrier gas was set to 1.0 mL/min and at a split injection ratio of 1:100. The temperature of the oven was initially set at 35° C. held for 5 min, increased to 100° C. at a rate of 3° C./min, further increased to 170° C. at a rate of 20° C./min, and finally the temperature of the oven was increased to 260° C. at 2° C./min and maintained for 5 min.

The hydrocarbon composition of samples collected after reaction step 1, alkene metathesis, was determined using GC-MS. Ten microliter of the sample was dissolved with 1 mL of acetone and the solution was injected in the GC-MS using the same protocol used in analyzing the derivatized oil fraction.

### Example 6: Metathesis of Camelina Oil with Propylene

A metathesis reaction of Camelina oil with propylene was carried out in the presence of Grubbs Catalyst C827 (Ruthenium, [1,3-bis-(2,4,6-trimethylphenyl)-2-imidazolidinylidene]dichloro(3-methyl-2-butenylidene)(tricyclohexylphosphine)) at 40° C. and 70 PSI. The structure of the C827 catalyst is:

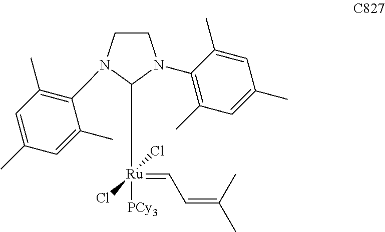

The metathesis product obtained by the above reaction comprised a mixture of C₉-C₁₃ olefins and olefins with less than C₉ atoms as shown below:

TABLE 1

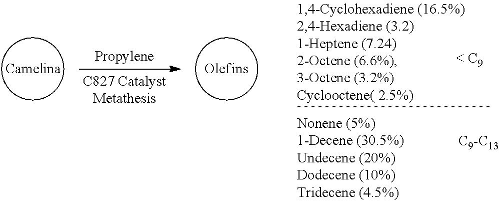

### Example 7: Synthesis of Bicyclic Hydrocarbons

Olefins with <C₉, such as those obtained in Example 6, have a lower boiling point than C₉-C₁₃ olefins and can be separated from the C₉-C₁₃ olefin fraction after metathesis by controlled fractional distillation. A [2+2] cycloaddition reaction will be carried out on the <C₉ olefin fraction in the presence or absence of an olefin isomerization reagent, such as 1,4-benzoquinone. 1,4-benzoquinone is known for the isomerization of 1,4-cyclohexane to 1,3-cyclohexene. The isomerization can be carried out during the distillation process for separating the <C₉ olefin fraction, i.e. isomerization can be carried out before the cycloaddition reaction. A [2+2] cycloaddition reaction will be performed thermally under pressure or photochemically under visible light in the presence of a ruthenium photocatalyst, such as Ru(bpm)₃⁺². Since cyclohexadiene is a major component of the <C₉ olefin fraction, 1-heptene, 2-octene, 3-octene and cyclooctene will randomly and predominantly react with cyclohexadiene to provide fused six- and four-membered bicyclic and polycyclic hydrocarbons upon catalytic hydrogenation as shown below:

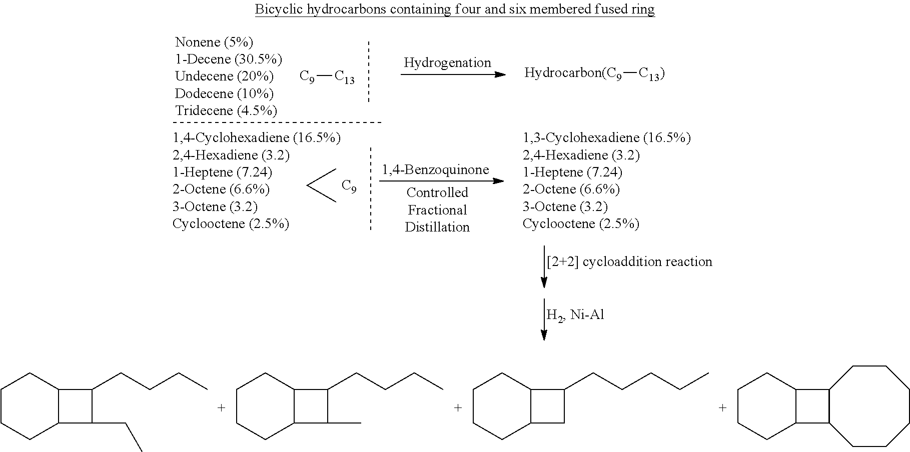

In another set of bicyclic hydrocarbon synthesis, a [4+2] cycloaddition reaction will be carried out on the <C₉ olefin fraction in the presence of an olefin isomerization reagent, such as 1,4-benzoquinone, where 1-heptene, 2-octene, 3-octene and cyclooctene will randomly react with 1,3-cyclohexadiene (obtained by isomerization of 1,4-cyclohexadiene) to form fused six-membered bicyclic hydrocarbons as shown below:

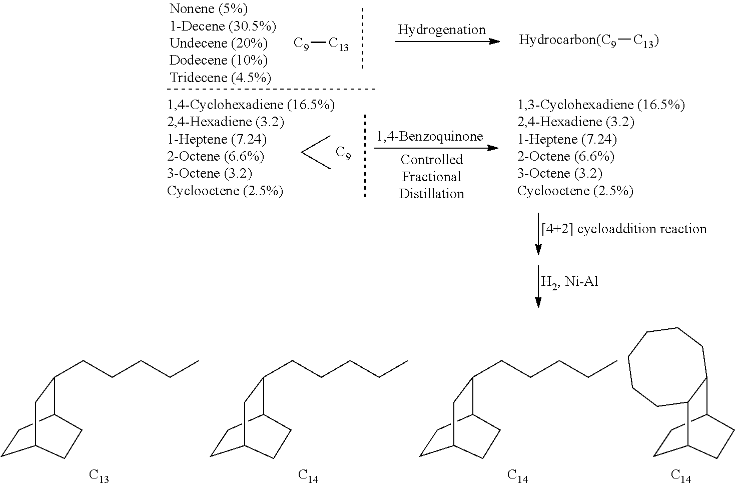

What is claimed is:

1. A method of preparing a transportation fuel comprising:
(a) Providing a renewable feedstock comprising an unsaturated fatty acid glyceryl ester;
(b) contacting a mixture of the feedstock and C₂-C₅ olefins with a metathesis catalyst whereby the unsaturated fatty acid glyceryl ester and C₂-C₅ olefin undergo a cross-metathesis reaction, thereby forming a metathesis product comprising medium-chain fatty glyceryl esters, acyclic olefins, cyclic olefins, and optionally unreacted C₂-C₅ olefins;
(c) dehydrogenating the metathesis product in the presence of a hydrogenation catalyst and substantially less than a stoichiometric amount of hydrogen gas relative to the amount of unsaturated bonds in the metathesis product, thereby forming a dehydrogenated metathesis product comprising medium-chain fatty glyceryl esters, acyclic olefins, cyclic olefins, optionally unreacted C₂-C₅ olefins, and aromatics;
(d) hydrogenating the dehydrogenated metathesis product in the presence of a hydrogenation catalyst and hydrogen, thereby forming a hydrogenated mixture comprising medium-chain saturated fatty glyceryl esters, acyclic and cyclic saturated hydrocarbons, and aromatics,
wherein the hydrogenated mixture, or a blend comprising at least 50% of the hydrogenated mixture and a fuel blendstock, meets or exceeds the specifications of jet fuel.

2. The method of claim 1, further comprising:
(e) distilling the hydrogenated mixture,
wherein at least one fraction obtained from the distilling of step (e), or a blend comprising at least 50% of the at least one fraction and a fuel blendstock, meets or exceeds the specifications of jet fuel.

3. The method of claim 2, wherein at least one other fraction obtained from the distilling of step (e) comprises at least 50% of the medium-chain saturated fatty glyceryl esters of the hydrogenated mixture.

4. The method of claim 2, wherein the at least one fraction obtained from the distilling of step (e), or a blend comprising at least 50% of the at least one fraction and a fuel blendstock, contains at least 21% aromatics.

5. The method of claim 2, wherein the at least one fraction obtained from the distilling of step (e), or a blend comprising at least 50% of the at least one fraction and a fuel blendstock, contains at least 25% aromatics.

6. The method of claim 1, wherein step (c) and step (d) are carried out in the same reactor, and wherein the hydrogenation catalyst of step (c) and the hydrogenation catalyst of step (d) are the same.

7. The method of claim 1, wherein the metathesis catalyst is a heterogeneous catalyst, further comprising reusing the metathesis catalyst for further metathesis without refining, wherein the metathesis catalyst is impregnated in a solid media.

8. The method of claim 1, wherein the renewable feedstock comprises camelina oil.

9. The method of claim 1, wherein the hydrogenated mixture comprises at least 5% aromatics.

10. The method of claim 1, further comprising:
(f) distilling the dehydrogenated metathesis product of step (c) to form an aromatics fraction, a medium-chain fatty glyceryl esters fraction, and a lower molecular weight fraction comprising C5-C16 olefins;
(g) contacting the lower molecular weight fraction with a metathesis catalyst whereby the C5-C16 olefins undergo a self-metathesis reaction, thereby forming a metathesis product comprising C8-C30 olefins; and
(h) hydrogenating the metathesis product of step (g) and the medium-chain fatty glyceryl esters fraction of step (f) in the presence of a hydrogenation catalyst and hydrogen, thereby forming a hydrogenated mixture comprising saturated medium-chain saturated fatty glyceryl esters and C8-C30 paraffins,
(i) distilling the hydrogenated mixture of step (h);
wherein the aromatics fraction of step (f), or a blend comprising at least 50% of the aromatics fraction and a fuel blendstock, meets or exceeds the specifications of jet fuel, wherein a C8-C22 paraffin fraction obtained from the distilling of step (i), or a blend comprising at least 50% of the C8-C22 paraffin fraction and a fuel blendstock meets or exceeds the specifications of diesel fuel, and wherein a heavier paraffin fraction (>C22) obtained from the distilling of step (i), or a blend comprising at least 50% of the heavier paraffin fraction and a commercial motor oil or a lubricant meets or exceeds the specifications of motor oil or the lubricant.

11. A method for preparing a transportation fuel comprising:
(a) providing a renewable feedstock comprising an unsaturated fatty acid glyceryl ester;
(b) contacting a mixture of the feedstock and C₂-C₅ olefins with a metathesis catalyst whereby the unsaturated fatty acid glyceryl ester and C₂-C₅ olefin undergo a cross-metathesis reaction, thereby forming a metathesis product comprising medium-chain fatty glyceryl esters, C₉-C₁₃ olefins, olefins with <C₉ atoms, and optionally unreacted C₂-C₅ olefins;
(c) separating a fraction containing C₉-C₁₃ olefins and a fraction containing olefins with <C₉ atoms;
(d) contacting the fraction containing olefins with <C₉ atoms with a cyclization catalyst in the presence of hydrogen, thereby forming a mixture comprising bicyclic and polycyclic hydrocarbons;
wherein the mixture comprising bicyclic and polycyclic hydrocarbons meets or exceeds the specifications of aviation fuel.

12. The method according to claim 11, further comprising contacting the fraction containing olefins with <C₉ atoms with an isomerization reagent prior to step (d).

13. The method according to claim 12, wherein the isomerization reagent is selected from the group consisting of 1,4-benzoquinone, NaBAr^{f}₄ (where Ar^{f} stands for 3,5-(CF₃)₂C₆H₃)), and Ni(COD)₂ (Nickel bis-cyclooctadiene).

14. The method according to claim 11, wherein the cyclization catalyst is selected from the group consisting of ruthenium (II) bipyrimidine (Ru(bpm)₃⁺²), and carbonylchlorohydrotris(triphenylphosphine)ruthenium(RuHCl(CO)(PPH₃)₃).

15. A metathesis catalyst comprising a Ru—(N-heterocyclic carbene) complex immobilized on silica.

16. The metathesis catalyst of claim 15, wherein the silica is functionalized to comprise azide or amide functional groups.

17. A metathesis catalyst comprising one or more Ru catalytic moieties linked to a polymerized N-heterocyclic carbene ligand.

18. The metathesis catalyst of claim 17, wherein the N-heterocyclic carbene ligand is functionalized to comprise alkyne functional groups.

19. The metathesis catalyst of claim 17, wherein the N-heterocyclic carbene ligand is functionalized to comprise alkene functional groups.
